(19) United States
(12) Patent Application Publication
(10) Pub. No.: US 2007/0216172 A1
(43) Pub. Date: Sep. 20, 2007

(54) Door handle with auxiliary indicator lamps

(76) Inventor: Yuan-Tai Chang, Hsinchu County (TW)

Correspondence Address: YUAN-TAI CHANG, 235 Chung - Ho, Box 8-24, Taipei, TW

(21) Appl. No.: 11/374,599

(22) Filed: Mar. 14, 2006

(51) Int. Cl. E05B 63/20

(52) U.S. Cl. 292/336

(57) ABSTRACT

A door handle with auxiliary indicator lamps comprises a door handle; a receiving groove formed in an outer side of the door handle; an outer side of the receiving groove having a stepped portion; the stepped portion having a plurality of recesses; a circuit board installed in the receiving groove for receiving a indicator lamp circuit; a plurality of LED lights installed on the circuit board; a washer arranged at the stepped portion of the receiving groove; a cover plate covering the opening and at an ouster side of the washer so that the washer having the effect of preventing objects to enter into the receiving groove; and a light transmitting plate installed at a central portion of the cover plate so that the light of the LED lights can transmit out of the light transmitting plate; and a lateral wall of the cover plate having plurality of protrusions.

### FIELD OF THE INVENTION

The present invention relates to cars, and in particular to a door handle with auxiliary indicator lamps, wherein auxiliary indicator lamps are installed in the door handle directly so as to increase the safety in driving and the outlook of the car can be retained so as to improve the defect of the prior art where indicator lamps are only installed at two sides of a car. Thereby the door handle is updateable.

### BACKGROUND OF THE INVENTION

Generally, a car is installed with indicator lamps, head lamps, or tail lamps so as to alert the cars backsides. However for a large vehicle, the above mentioned lamps are not sufficient due to a long body and the dead angle in viewing. Thus it is dangerous. Furthermore, for a small car, in turning, if motorcycle comes from lateral sides, the motorcycle cannot sense the indicator at the head or tail sides, or if the motorcycles are at the dead angle of the car, it will be at a dangerous state.

For above mentioned problem, auxiliary indicator lamps are installed at the lateral plates of a car. The casing of the indicator lamp is installed at the lower side of a car. However the holes must be formed for installing the indicator lamp. As a result the outlook of the car is destroyed. Thus, it is not a suitable design.

### SUMMARY OF THE INVENTION

Accordingly, the primary object of the present invention is to provide a door handle with auxiliary indicator lamps, wherein auxiliary indicator lamps are installed in the door handle 1 directly so as to increase the safety in driving and the outlook of the car can be retained so as to improve the defect of the prior art where indicator lamps are only installed at two sides of a car. Thereby the door handle 1 is updateable. Thus the auxiliary indicator lamps can be installed easily. The old door handle can be replaced by the present invention. The cost is low and operation is easy.

To achieve above objects, the present invention provides a door handle with auxiliary indicator lamps which comprises a door handle; a receiving groove formed in an outer side of the door handle; an outer side of the receiving groove having a stepped portion; the stepped portion having a plurality of recesses; a circuit board installed in the receiving groove for receiving a indicator lamp circuit; a plurality of LED lights installed on the circuit board; a washer arranged at the stepped portion of the receiving groove; a cover plate covering the opening of the door handle and at an ouster side of the washer so that the washer having the effect of preventing objects to enter into the receiving groove; and a light transmitting plate installed at a central portion of the cover plate so that the light of the LED lights can transmit out of the light transmitting plate; a lateral wall of the cover plate having plurality of protrusions; wherein in assembly, the protrusions are installed in the recesses of the stepped portion.

The various objects and advantages of the present invention will be more readily understood from the following detailed description when read in conjunction with the appended drawing.

### BRIEF DESCRIPTION OF THE DRAWINGS

FIG. 1 is an exploded schematic view of the door handle of the present invention.

FIG. 2 is a schematic perspective view of the door handle of the present invention.

FIG. 3 shows the installation of the present invention.

FIG. 4 shows the use of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

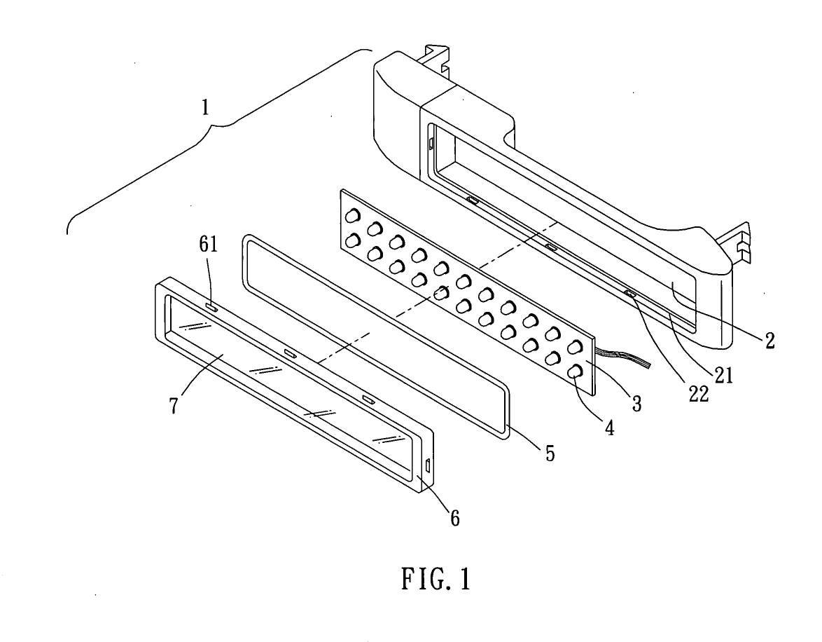

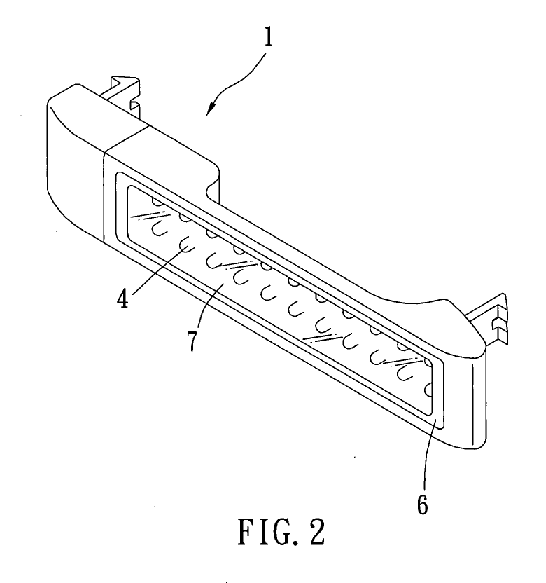

Referring to FIGS. 1 to 2, the present invention is illustrated. The present invention has the following elements.

A door handle 1 has indicator lamps.

A receiving groove 2 is formed in an outer side of the door handle 1. An outer side of the receiving groove 2 has a stepped portion 21. The stepped portion 21 has a plurality of recesses 22.

A circuit board 3 is installed in the receiving groove 2 for receiving a indicator lamp circuit.

A plurality of LED lights 4 are installed on the circuit board 3.

A washer 5 is arranged at the stepped portion 21 of the receiving groove 2.

A cover plate 6 covers the opening of the door handle 1 and at an ouster side of the washer 5 so that the washer 5 has the effect of preventing objects to enter into the receiving groove 2.

A light transmitting plate 7 is installed at a central portion of the cover plate 6 so that the light of the LED lights 4 can transmit out of the light transmitting plate 7. A lateral wall of the cover plate 6 has plurality of protrusions 61. In assembly, the protrusions 61 are installed in the recesses 22 of the stepped portion 21.

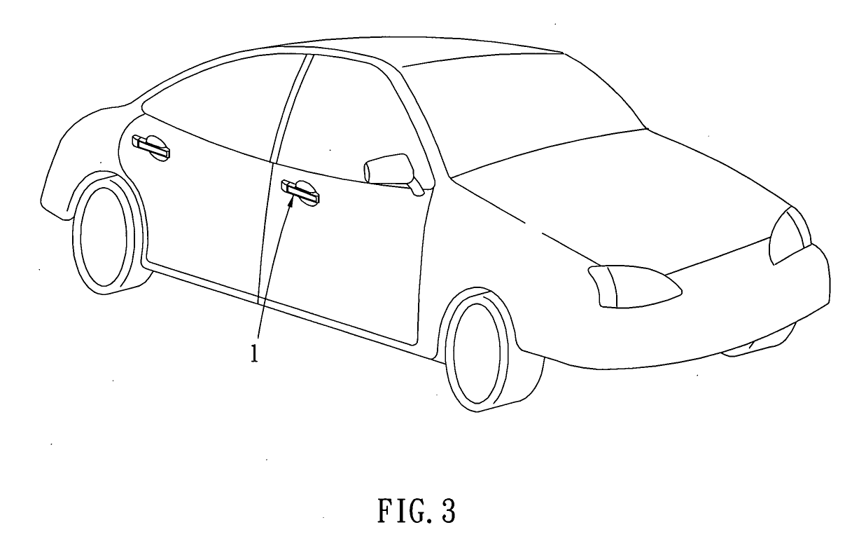

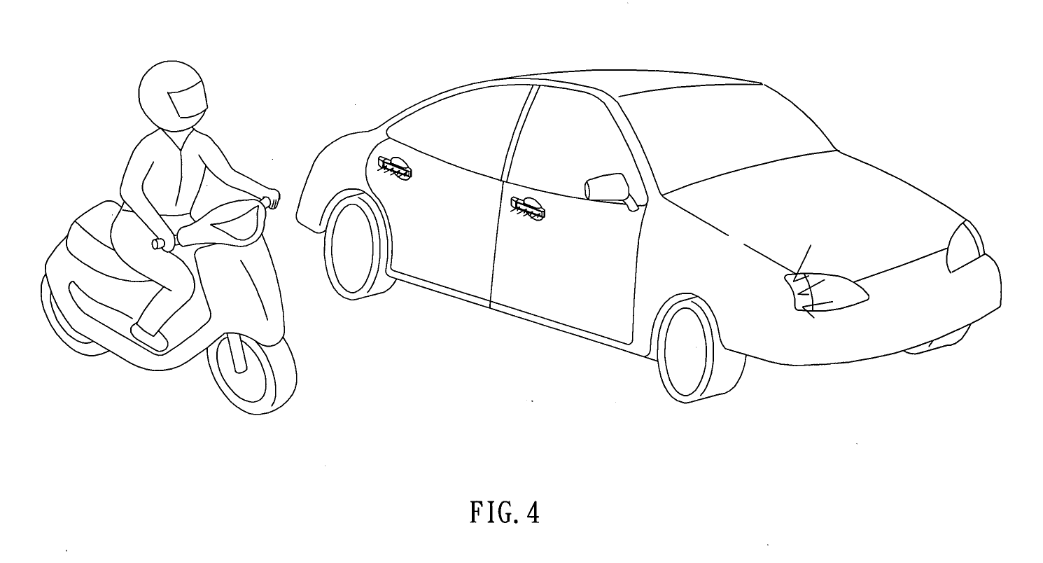

In use of the present invention, referring to FIGS. 3 and 4, when a car is installed with the auxiliary indicator lamp of the present invention, the door handle 1 acts with the action of the indicator lamp. If a car comes from a lateral side, the car at the lateral side will discover the action of the car at the front side installed with the present invention so as to increase the safety in driving.

Moreover in the present invention, the door handle 1 is installed with auxiliary indicator lamps which acts with the action of the indicator lamps of the car. It will not destroy the outlook of the car.

Advantages of the present invention will be described herein. In the present invention, auxiliary indicator lamps are installed in the door handle 1 directly so as to increase the safety in driving and the outlook of the car can be retained so as to improve the defect of the prior art where indicator lamps are only installed at two sides of a car. Thereby the door handle 1 is updateable. Thus the auxiliary indicator lamps can be installed easily. The old door handle can be replaced by the present invention. The cost is low and operation is easy.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A door handle with auxiliary indicator lamps comprising:
a door handle;
a receiving groove formed in an outer side of the door handle; an outer side of the receiving groove having a stepped portion; the stepped portion having a plurality of recesses;
a circuit board installed in the receiving groove for receiving a indicator lamp circuit;
a plurality of LED lights installed on the circuit board;
a washer arranged at the stepped portion of the receiving groove;
a cover plate covering the opening of the door handle and at an ouster side of the washer so that the washer having the effect of preventing objects to enter into the receiving groove; and
a light transmitting plate installed at a central portion of the cover plate so that the light of the LED lights can transmit out of the light transmitting plate; a lateral wall of the cover plate having plurality of protrusions; wherein in assembly, the protrusions are installed in the recesses of the stepped portion.
